(19) United States
(12) Patent Application Publication
(10) Pub. No.: US 2005/0050168 A1
(43) Pub. Date: Mar. 3, 2005

(54) Real time learning system over worldwide network

(75) Inventors: Shih-Li Wen, Taipei (TW); Yun-Yang Chang, Taipei (TW); Hsiang-Min Liu, Taipei (TW); Chiu-Yin Lin, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 10/648,333

(22) Filed: Aug. 27, 2003

(51) Int. Cl. G06F 15/16

(52) U.S. Cl. 709/219

(57) ABSTRACT

The present invention is to provide a real time learning system established between at least one teacher's computer and at least one learner's computer over the Internet. Each of the teacher's and learner's computer has a video platform of real time learning coupled to a server of real time learning-over the Internet, and enables each teacher or learner to send personal data to the server capable of classifying and mating qualified teachers with qualified learners over the Internet and carrying out an interactive teaching between the teacher's and the learner's computers.

### FIELD OF THE INVENTION

The present invention relates to learning system over a worldwide network of computers and more particularly to a real time learning system over the Internet with improved characteristics.

### BACKGROUND OF THE INVENTION

Information technology has known a rapid, spectacular development in recent decades leading to a wide use of inexpensive, convenient personal computers and the fast Internet in our daily life and work. The proliferation of computers and the Internet has changed our longtime thinking style about information. For example, a small computer can store data more than a typical encyclopedia. As to the Internet, a person can access it for retrieving information from millions of sources, including governments, businesses, individuals, etc. Most importantly, you can retrieve information in a real time manner in any place in the world. Thus, there is no need to worry that it is not easy to retrieve information in this information explosion age. However, large, various sources of information also may cause shock and bring troubles to people in learning. To the worse, a person may be aimless in learning by retrieving various sources of information from the Internet. Hence, it is important for most people how to retrieve desired information, correctly learn from the retrieved information, and select channels for learning from the information in the information explosion age.

It is known that personal computers and the Internet are increasingly popular among people. In this fast changing world, it is desired that people living in the information age should take career learning as part of their daily life in order to get knowledge for facilitating their work and as a means for improving life. As such, there is a trend of learning over the Internet in recent years because the Internet can provide another channel of learning in addition to typical ones. In other words, the Internet provides a bridge between a teacher and learners. Also, rather than one way learning or teaching the learning network provides an interactive learning or teaching for communicating information. It is contemplated that network teaching will be a shining star in applications of the Internet because people have a strong desire of learning in this information age.

There are two techniques implemented in the current network teaching based on people groups and teaching content. Namely, one is synchronous course delivery (SCD). The SCD emphasizes communication of real time information. That is, all participants including learners and teachers have to send information simultaneously over the Internet, resulting in an interaction between the learners and the teachers. The SCD is applicable to online discussion, video conference, etc. The other one is asynchronous course delivery (ACD). The ACD places learning content in a teaching Web site in advance so that a learner can access the Internet for retrieving the learning content from the teaching Web site in any time any place without restriction. The ACD is the dominant one of the current network teaching.

The network teaching has advantages of learning anywhere and learning any time. As such, a learner can carry out network learning over the Internet in any available network environment without any restriction of space. It is contemplated that such new mode of education will be the dominant mode of education in the 21st century. The new mode of education emphasizes learners as center and personal and independent learning. As such, vast people who are busy in work may take network learning as an additional channel of getting knowledge without being restricted by space since they are unfortunately bound by work and course schedule.

However, the typical network teaching as implemented by ACD always requires a teacher to record teaching programs (containing text, pictures, sound, and video) in advance prior to placing it on the Internet for retrieving by learners. Unfortunately, it is often that vast learners may not satisfy with the content of the teaching programs (containing text, pictures, sound, and video) due to various needs of learners. Moreover, experiences, specialties, and the number of teachers may limit the content of the teaching programs. Further, there is no interaction between learners and a teacher. In other words, learners have to learn step by step as syllabus goes. Such may be appropriate for the learning of basic courses rather than advanced ones. In view of the above, it is concluded that the prior network teaching cannot satisfy various needs of learners due to limited educational resources. Thus, the need for improvement still exists.

### SUMMARY OF THE INVENTION

A primary object of the present invention is to provide a real time learning system established between at least one teacher's computer and at least one learner's computer over the Internet. Each of the teacher's computer and each of the learner's computer has a video platform of real time learning coupled to a server of real time learning over the Internet, thereby carrying out an interactive teaching between the teacher's computer and the learner's computer. By utilizing the present invention, the above drawback of the prior art can be overcome. The drawback is that the prior network teaching cannot satisfy various needs of learners due to limited educational resources.

In one aspect of the present invention, each teacher or learner is able to send personal data including education, experience, password, computer location, etc. and teaching (or learning) data including topics, courses, content, charge, etc. to the server by using his/her computer. The server then classifies the same prior to mating qualified teachers with qualified learners over the Internet. In such a manner, it is able to permit both any teacher having specialties and profound knowledge to find a desired learner and any learner, who wants to get knowledge, to find a desired teacher by utilizing the free, open, and safe network based education environment of the present invention. In brief, the network education of the present invention can fulfill the needs of vast learners.

In another aspect of the present invention, the server is able to perform a safety check on personal data inputted by the teacher's computer or the learner's computer, select qualified learners and teachers based on proposed conditions, and mate the qualified learners with the qualified teachers so as to provide a safe mating mechanism in the free, open network based education environment of the present invention.

In still another aspect of the present invention, after mating qualified learners with qualified teachers over the Internet based on proposed conditions by the server, the teacher's computer or the learner's computer can send video and audio data for teaching or learning over the Internet in order to ensure a high efficient data transfer and confidentiality. As to the server, it is responsible for supervising accumulated online time of teaching or learning and calculating charge incurred thereby.

The above and other objects, features and advantages of the present invention will become apparent from the following detailed description taken with the accompanying drawings.

### BRIEF DESCRIPTION OF THE DRAWINGS

FIG. 1 presents schematically the connection of a structure applicable for an embodiment of real time learning system over worldwide network according to the invention;

FIG. 2 depicts the structure of a video platform of real time learning installed on either a teacher's computer or learner's computer according to the invention,

FIG. 3 presents schematically a point to point connection of the teacher's computer to the learner's computer via a server over the Internet according to the invention;

FIG. 4 presents schematically a distributed node group connection of the teacher's computer to the learner's computer via the server over the Internet according to the invention;

FIG. 5 presents a flow chart of one embodiment of the invention for illustration of one learner in searching a desired teacher with respect to a specified learning topic; and

FIG. 6 depicts the structure of the server of the invention.

### DETAILED DESCRIPTION OF THE PREFERRED EMBODIMENTS

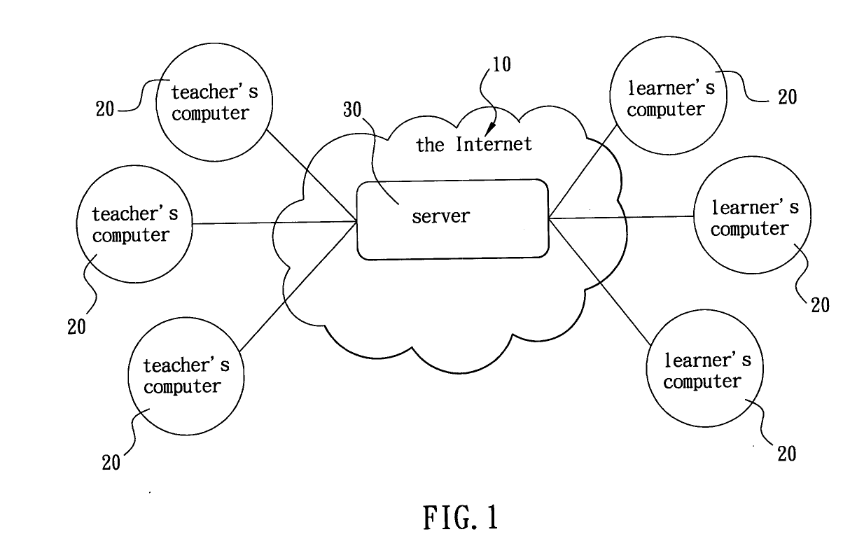

Referring to FIGS. 1, 2 and 3, there is shown a real time learning system over worldwide network in accordance with the invention. The system is established between at least one teacher's computer 20 and at least one learner's computer 20 over the Internet 10. Each computer 20 has a video platform 21 of real time learning which is coupled to a server 30 of real time learning over the Internet 10. Also, each teacher or learner is able to send personal data including education, experience, password, computer location, etc. and teaching (or learning) data including topics, courses, content, charge, etc. to the server 30. The server 30 then classifies the same prior to allowing other teachers or learners to access it. In such a manner, a teacher or learner can use his/her own computer 20 to search a desired learner or teacher over the Internet 10. Further, the teacher's computer 20 and the learner's computer 20 can be coupled together immediately if the desired one is found. Next, video education including learning data transfer can be carried out. As to the server 30, it is responsible for supervising accumulated online time of education or learning and calculating charge incurred thereby.

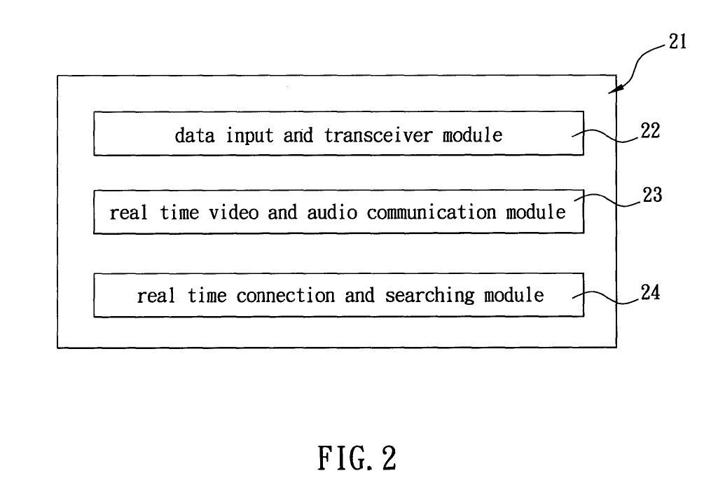

In the invention (see FIGS. 1 and 2) the video platform 21 of real time learning mounted in each of the teacher's computers 20 and the learner's computers 20 comprises a data input and transceiver module 22, a real time video and audio communication module 23, and a real time connection and searching module 24. The data input and transceiver module 22 is adapted to cause the teacher's computer 20 or the learner's computer 20 to perform the following operations:

(1) Inputting basic data: A learner or teacher can use his/her computer 20 to input personal data including address, education, experience, password, computer location, etc. For recording by means of the data input and transceiver module 22. Further, qualification check of teacher is performed and the qualified teacher is sent from the computer 20 to the server 30 for classification and management thereafter.

(2) Inputting teaching topics: Each teacher can use his/her computer 20 to input data about teaching including topics, courses, contents, charge, etc. for recording by means of the data input and transceiver module 22. The recorded data about teaching is then sent from the computer 20 to the server 30 for classification and management thereafter. Moreover, the data input and transceiver module 22 is adapted to retrieve relevant learner data from the server 30 for interconnecting the teacher's computers 20 and the learner's computers 20 or interconnecting learners who are searching a desired teacher over the Internet 10.

(3) Inputting learning topics: Each learner can use his/her computer 20 to input data about learning including topics, courses, contents, charge, etc. for recording by means of the data input and transceiver module 22. The recorded data about learning is then sent from the computer 20 to the server 30 for classification and management thereafter. Moreover, the data input and transceiver module 22 is adapted to retrieve relevant teacher data from the server 30 for interconnecting the teacher's computers 20 and the learner's computers 20 or interconnecting teachers who are searching desired learners over the Internet 10.

(4) Sharing learning data: Each learner or teacher can use his/her computer 20 to input data records or files about learning or teaching. The input data is then sent from the computer 20 to the server 30 available for searching or downloading by other learners or teachers.

(5) Downloading learning content: Each learner or teacher can use his/her computer 20 to download learning or teaching data records or files from the server 30 via the data input and transceiver module 22.

In the invention the real time video and audio communication module 23 is adapted to cause the teacher's computer 20 or the learner's computer 20 to perform the following operations:

(1) Real time video communication: Each learner or teacher can use his/her computer 20 (having a coupled peripheral capable of performing video and audio communication) to connect to the server 30. After connected, the computer 20 is able to cause the real time video and audio communication module 23 to establish a video connection over the Internet 10 for performing an online real time video (including audio) teaching or learning.

(2) Real time online display: Each qualified learner or teacher can use his/her computer 20 to receive information sent from the server 30 by broadcasting via the real time video and audio communication module 23. The received information is then shown on the computer 20 for display.

(3) Real time online sending: Each learner or teacher can use his/her computer 20 to convert information shown on the computer 20 into video/audio stream via the real time video and audio communication module 23. The video/audio stream is then sent from the computer 20 to the server 30 which in turn broadcasts the same to relevant teacher's computers 20 or learner's computers 20.

In the invention the real time connection and searching module 24 is adapted to cause the teacher's computer 20 or the learner's computer 20 to perform the following operations:

(1) Real time online searching: Each learner or teacher can use his/her computer 20 to search shared learning data available for other teachers or learners based on input data in the server 30 via the real time connection and searching module 24.

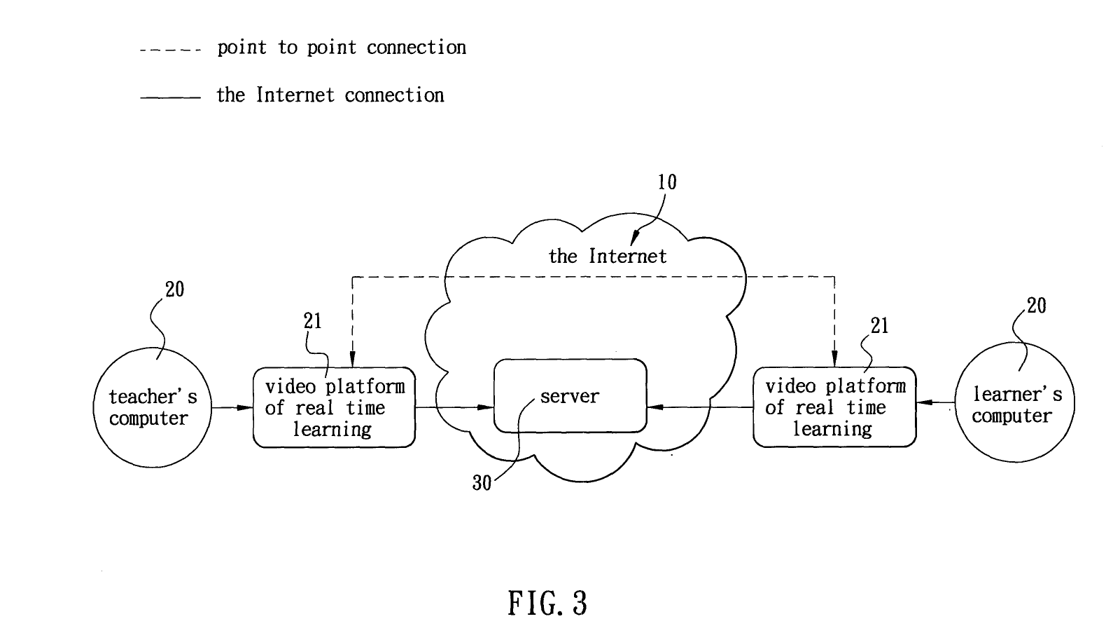

(2) Calling and searching others: Each learner or teacher can use his/her computer 20 to input location data about the teacher's computer 20 or the learner's computer 20 so as to establish a point to point connection with any of other teacher's computers 20 or learner's computers 20 via the server 30 (see FIG. 3).

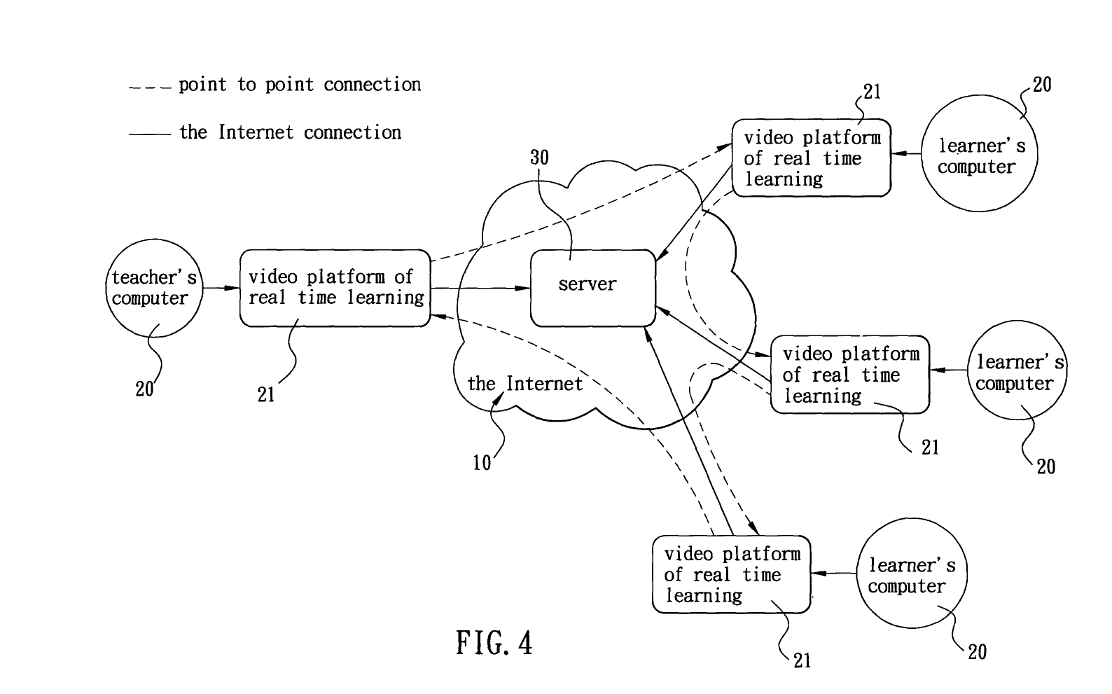

(3) Connecting to other nodes: Each learner or teacher can use his/her computer 20 to input node location data about the teacher's computer 20 or the learner's computer 20 so as to establish a distributed node group connection with any of other teacher's computers 20 or learner's computers 20 via the server 30 (see FIG. 4).

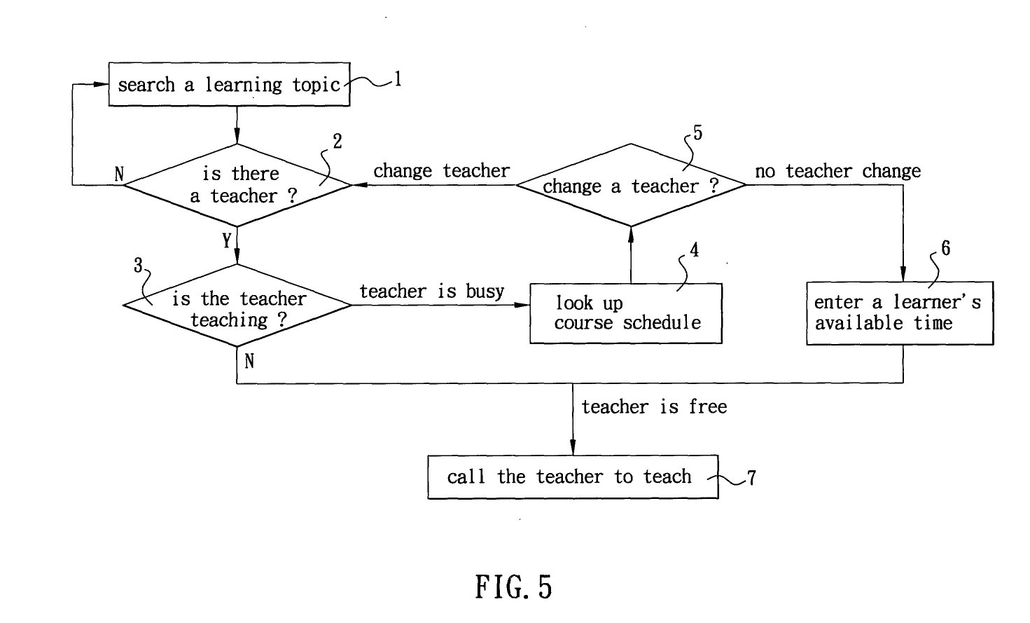

In the invention all teacher's computers 20 or learner's computers 20 are coupled to the server 30 after have finished the connection with the Internet 10. Next, each computer 20 can retrieve relevant information about all recorded and qualified learners or teachers from the server 30 for learner or teacher reference. Referring to FIG. 5, a process of one learner in searching a desired teacher with respect to a specified learning topic is illustrated. The learner can use his/her computer to perform the following operations for searching and selection:

In step 1, a learner use his/her computer 20 to search a desired teacher who is capable of teaching a specified learning topic as or similar to that desired by the learner.

In step 2, determine whether such teacher (i.e., who is capable of teaching a specified learning topic as or similar to that desired by the learner) has been found. If yes, the process goes to step 3. Otherwise, the process loops back to step 1 for continuation.

In step 3, determine whether the teacher is teaching. If yes, the process goes to step 4. Otherwise, the process jumps to step 7.

In step 4, a learner looks up course schedule for finding an appropriate time of attending the class based on his/her available time.

In step 5, a learner determines whether there is a need to change to another teacher who is capable of teaching a specified learning topic as or similar to that desired by the learner based on his/her available time. If yes, the process loops back to step 2 for changing. Otherwise, the process goes to step 6.

In step 6, input a learner's available time for reserving a glass time with the teacher.

In step 7, a learner uses his/her computer 20 to connect to the teacher's computer 20 and then calls the teacher to teach or reserve a glass time with the teacher via the Internet 10. In such a manner, if the teacher satisfies with conditions proposed by and received from a learner, both parties may agree to establish a connection therebetween over the Internet 10. Thereafter, information about teaching or learning can be communicated between the learner and the teacher without involvement of the server 30 which, as stated above, is only responsible for supervising accumulated online time of education or learning and calculating charge incurred thereby.

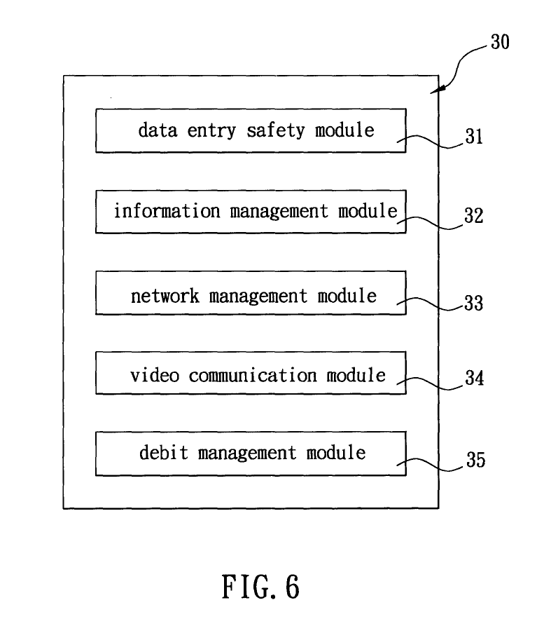

Moreover, for enabling vast learners and teachers to utilize the real time learning system over worldwide network (e.g., the Internet 10) of the invention for carrying out a real time learning or teaching the server 30 must ensure a safe environment and high efficiency in accessing the Internet 10. As such, as illustrated in the structure of the server 30 of FIG. 6, the server 30 comprises, but not limited to, at least one data entry safety module 31, an information management module 32, a network management module 33, a video communication module 34, and a debit management module 35. The data entry safety module 31 is adapted to cause the server 30 to receive personal data from the teacher's computer 20 or the learner's computer 20, perform a safety check and qualification check thereon, classify and manage the same, select qualified learners and teachers based on proposed conditions, and mating learners with teachers so as to provide a safe and highly efficient learning and teaching mechanism. The information management module 32 is adapted to cause the server 30 to receive learning or teaching data such as learning or teaching topics, content, shared learning data, charge, etc. From the teacher's computer 20 or the learner's computer 20 and classify the same so as to be available for searching or downloading by other learners or teachers. The network management module 33 is adapted to cause the server 30 to perform a point to point connection or distributed node group connection between the teacher's computer 20 and the learner's computer 20 based on computer location data sent from the teacher's computer 20 and the learner's computer 20. The video communication module 34 is adapted to cause the server 30 to receive video data including audio data from the teacher's computer 20 or the learner's computer 20 and immediately thereafter broadcast the same to a relevant teacher's computer 20 or learner's computer 20. The debit management module 35 is adapted to cause the server 30 to identify whether the learners (i.e., learner's computers 20) and the teachers (i.e., teacher's computers 20) are coupled together via the Internet 10 for communicating information while learning or teaching, monitor the connection therebetween, calculate learning or teaching charge incurred thereby based on the accumulated online time, and ensure a high efficient data transfer and confidentiality.

In view of the above, the real time learning system over worldwide network of the invention can enable a teacher or learner to actively connect to the server 30 via the associated video platform 21 of real time learning. Once connected, any teacher, having specialties and profound knowledge and being capable of teaching courses, topics, or the like interesting to learners, can teach the learners. Moreover, any learner, who wants to get knowledge, can find a desired learning course or topic and a desired teacher by utilizing the free, open, and safe network based education environment of the invention. In brief, the network education of the invention can fulfill the needs of vast learners.

While the invention has been described by means of specific embodiments, numerous modifications and variations could be made thereto by those skilled in the art without departing from the scope and spirit of the invention set forth in the claims.

1. A global real time learning system established between at least one teacher's computer and at least one learner's computer over the Internet, the system comprising:
a video platform of real time learning mounted in each of the teacher's computer and the learner's computer, the video platform of real time learning being available for a teacher or learner to input personal data and teaching or learning data; and
a server of real time learning coupled to each of the teacher's computer and the learner's computer over the Internet, the server of real time learning being adapted to receive information from the video platform of real time learning and classify the information prior to opening the information for accessing;
wherein the teacher's computer and the learner's computer can search one learner's computer and one teacher's computer conformed with set conditions over the Internet respectively for connection and perform video teaching or learning information communication between the teacher's computer and the learner's computer, and the server is adapted to supervise accumulated online time of teaching or learning and calculate charge incurred thereby.

2. The real time learning system of claim 1, wherein the video platform of real time learning comprises a data input and transceiver module for causing the teacher's computer or the learner's computer to input personal data for recording and sending the recorded data from the teacher's computer or the learner's computer to the server for classification and management thereafter.

3. The real time learning system of claim 2, wherein the data input and transceiver module is adapted to cause the teacher's computer or the learner's computer to input data for recording, send the recorded data from the teacher's computer or the learner's computer to the server for classification and management thereafter, and retrieve relevant learner information from the server or retrieve relevant teacher information from the server.

4. The real time learning system of claim 2, wherein the data input and transceiver module is adapted to cause the teacher's computer or the learner's computer to input data records or files about learning or teaching and send the input data records or files from the teacher's computer or the learner's computer to the server available for searching or downloading by other learners or teachers.

5. The real time learning system of claim 2, wherein the data input and transceiver module is adapted to cause the teacher's computer or the learner's computer to download data records or files about learning from the server via the real time video and audio communication module.

6. The real time learning system of claim 1, wherein the video platform of real time learning further comprises a real time video and audio communication module for causing the teacher's computer or the learner's computer to connect to the server, and thereafter causing the real time video and audio communication module to establish a video connection over the Internet for performing an online real time video teaching or learning.

7. The real time learning system of claim 6, wherein the real time video and audio communication module is adapted to cause the teacher's computer or the learner's computer to receive information sent from the server by broadcasting, and show the received information on the teacher's computer or the learner's computer.

8. The real time learning system of claim 6, wherein the real time video and audio communication module is adapted to cause the teacher's computer or the learner's computer to convert information shown on the computer into video/audio stream, send the video/audio stream from the teacher's computer or the learner's computer to the server, and cause the server to broadcast the same to relevant one of the teacher's computer or the learner's computer.

9. The real time learning system of claim 1, wherein the video platform of real time learning further comprises a real time connection and searching module for causing the teacher's computer or the learner's computer to search shared learning data available for other teachers or learners based on input data in the server.

10. The real time learning system of claim 9, wherein the real time connection and searching module is adapted to cause the teacher's computer or the learner's computer to input location data about the teacher's computer or the learner's computer for establishing a point to point connection with the other teacher's computer or learner's computer via the server.

11. The real time learning system of claim 9, wherein the real time connection and searching module is adapted to cause the teacher's computer or the learner's computer to input node location data about the teacher's computer or the learner's computer for establishing a distributed node group connection with the other teacher's computer or learner's computer via the server.

12. The real time learning system of claim 1, wherein the server comprises at least one data entry safety module for causing the server to receive personal data from the teacher's computer or the learner's computer, performing a safety check and qualification check thereon, and classifying and managing the same thereafter.

13. The real time learning system of claim 1, wherein the server further comprises a information management module for causing the server to receive learning or teaching information from the teacher's computer or the learner's computer, and classifying the same so as to be available for searching or downloading by other learners or teachers.

14. The real time learning system of claim 1, wherein the server further comprises a network management module for causing the server to perform a point to point connection or distributed node group connection between the teacher's computer and the learner's computer based on computer location data sent from the teacher's computer or the learner's computer.

15. The real time learning system of claim 1, wherein the server further comprises a video communication module for causing the server to receive video data including audio data from the teacher's computer or the learner's computer, and immediately thereafter broadcasting the same to relevant one of the teacher's computer or the learner's computer.

16. The real time learning system of claim 1, wherein the server further comprises a debit management module for causing the server to identify whether the learner's computer and the teacher's computer are connected together via the Internet for communicating information while learning or teaching, monitoring the connection therebetween, and calculating learning or teaching charge incurred thereby based on the accumulated online time.
